(19) United States
(12) Patent Application Publication
(10) Pub. No.: US 2004/0260604 A1
(43) Pub. Date: Dec. 23, 2004

(54) Methods and systems for location-based yellow page services

(76) Inventor: James C. Bedingfield SR., Lilburn, GA (US)

Correspondence Address: BELLSOUTH CORPORATION, P.O. BOX 2903, MINNEAPOLIS, MN, 55402-0903, US

(21) Appl. No.: 10/026,836

(22) Filed: Dec. 27, 2001

(51) Int. Cl. G06F 17/60

(52) U.S. Cl. 705/14

(57) ABSTRACT

Embodiments of the present invention relate to systems and methods for providing location-based yellow pages information. In an embodiment, the system includes a yellow pages database. The yellow pages database can include a plurality of advertiser entries. Each advertiser entry of at least a subset of the plurality of advertiser entries can include an advertiser identifier field to store an advertiser identifier and an advertiser measured location information field to store advertiser measured location information.

### BACKGROUND OF THE INVENTION

1. Field of the Invention

Embodiments of the present invention relate to location-based services. More particularly, embodiments of the present invention relate to systems and methods for location-based yellow page services.

2. Background Information

Known yellow pages include a directory of advertisers and associated information (e.g., business name, business telephone numbers, business address, business e-mail address, business network address (e.g., www.businessaddress.net), etc.) classified by category of advertiser. For example, a consumer may want to identify and/or locate business establishments (e.g., stores, offices, etc.) of a particular business type (e.g., hardware, computers, pool services, department stores, movie theatres, etc.). The consumer can view the section of the yellow pages associated with that particular business type, and that section typically lists one or more business establishments of the particular business type. Advertisers typically pay a fee to the publisher of the yellow pages to be listed in the yellow pages, but do not pay a supplemental fee to include information such as a phone number, a street address, a city identifier, a zip code, and so on. The yellow pages can be published as a hard copy or may be electronically accessible. Examples of known electronically accessible yellow pages include yellow pages accessed via a network (e.g., the Internet, the Web, an intranet, etc.), via a computer-readable medium (e.g., a compact-disc read only memory (“CD-ROM”), via a telephone company service, and so on. Yellow pages accessed via a telephone company service can include an operator-assisted service, an interactive voice response (“IVR”) system, and so on.

A known method of finding a business establishment in a specific location based on location information in yellow pages listings includes identifying zip codes of business establishments listed in the yellow pages. For example, a reader of a yellow pages book can visually scan through yellow pages listings to identify businesses having a particular zip code. Another known method of finding a business establishment at or around a specific location based on location information in yellow pages listings includes identifying business establishments having the same telephone area code and/or telephone exchange. Known electronically-accessible yellow pages allow a user to request information about a category of businesses in a specific zip code, area code, locality (e.g., city, town, state, etc.), and so on. Zip code, area code, and telephone exchange location information is typically not very precise. In view of the foregoing, it can be appreciated that a substantial need exists for systems and methods that can advantageously provide for location-based yellow page services.

### BRIEF SUMMARY OF THE INVENTION

Embodiments of the present invention relate to systems and methods for providing location-based yellow pages information. In an embodiment, the system includes a yellow pages database. The yellow pages database can include a plurality of advertiser entries. Each advertiser entry of at least a subset of the plurality of advertiser entries includes an advertiser identifier field to store an advertiser identifier and an advertiser measured location information field to store advertiser measured location information.

In another embodiment, a system for providing location-based yellow pages information can include a first server that contains a processor, a network port coupled to the processor, and a memory coupled to the processor. The memory stores a plurality of instructions configured to be executed by the processor. The plurality of instructions can include location-based yellow pages database access instructions. The system can also include a yellow pages database coupled to the first server. The yellow pages database can include a plurality of advertiser entries. Each advertiser entry of at least a first subset of the plurality of advertiser entries can include advertiser measured location information, and each advertiser entry of at least a second subset of the plurality of advertiser entries can lack advertiser measured location information.

As a further summary example, a method for providing location-based yellow pages information may include storing a plurality of advertiser entries in a yellow pages database, where each advertiser entry of at least a first subset of the plurality of advertiser entries includes an advertiser identifier field to store an advertiser identifier, an advertiser category identifier field to store one or more category identifiers, and an advertiser measured location information field to store advertiser measured location information. The method may include storing advertiser measured location information in at least each advertiser entry of a second subset of the plurality of advertiser entries, where the second subset of the plurality of advertiser entries is a subset of the first subset of the plurality of advertiser entries. User measured location information and user advertiser category identifier may be received. One or more advertiser entries of the plurality of advertiser entries may be selected based at least in part on the user advertiser category identifier. The selected one or more advertiser entries may be presented based at least in part on the user measured location information and the advertiser measured location information of the selected one or more advertiser entries.

According to another embodiment of the present invention, a system for providing location-based yellow pages information includes means for storing a plurality of advertiser entries in a yellow pages database. Each advertiser entry of at least a first subset of the plurality of advertiser entries may include an advertiser identifier field to store an advertiser identifier, an advertiser category identifier field to store one or more category identifiers, and an advertiser measured location information field to store advertiser measured location information. The system may also include means for storing advertiser measured location information in at least each advertiser entry of a second subset of the plurality of advertiser entries, where the second subset of the plurality of advertiser entries is a subset of the first subset of the plurality of advertiser entries. In addition, the system may include means for receiving user measured location information and means for receiving a user advertiser category identifier. Means for selecting one or more advertiser entries of the plurality of advertiser entries based at least in part on the user advertiser category identifier may be part of the system. The system can further include means for presenting the selected one or more advertiser entries based at least in part on the user measured location information and the advertiser measured location information of the selected one or more advertiser entries.

In another embodiment of the present invention, a method for providing location-based yellow pages information can include a step for storing a plurality of advertiser entries in a yellow pages database. Each advertiser entry of at least a first subset of the plurality of advertiser entries includes an advertiser identifier field to store an advertiser identifier, an advertiser category identifier field to store one or more category identifiers, and an advertiser measured location information field to store advertiser measured location information. The method also includes a step for storing advertiser measured location information in at least each advertiser entry of a second subset of the plurality of advertiser entries, where the second subset of the plurality of advertiser entries is a subset of the first subset of the plurality of advertiser entries. According to the method, there is a step for receiving user measured location information and a step for receiving a user advertiser category identifier. There is also a step for selecting one or more advertiser entries of the plurality of advertiser entries based at least in part on the user advertiser category identifier. The method also includes a step for presenting the selected one or more advertiser entries based at least in part on the user measured location information and the advertiser measured location information of the selected one or more advertiser entries.

According to another embodiment of the present invention, a method of providing a location-based yellow pages service includes operating a yellow pages service that includes a yellow pages database. The yellow pages database can include a first set of advertiser entries and a second set of advertiser entries. The first set of advertiser entries includes advertiser measured location information, and the second set of advertiser entries lacking advertiser measured location information. The advertisers corresponding to the first set of advertiser entries are charged a fee to include advertiser measured location information in the yellow pages database.

In a further embodiment of the present invention, a method of providing a location-based yellow pages service includes operating a yellow pages service that contains a first advertiser's information and a second advertiser's information. The first advertiser's information includes measured location information, and the second advertiser's information lacks measured location information. The first advertiser is charged an additional fee based at least in part on including measured location information as part of the first advertiser's information.

According to a further embodiment of the present invention, a computer-readable medium stores a plurality of instructions to be executed by a processor for providing location-based yellow pages information. The plurality of instructions includes instructions to store a plurality of advertiser entries in a yellow pages database. Each advertiser entry of at least a first subset of the plurality of advertiser entries including an advertiser identifier field to store an advertiser identifier, an advertiser category identifier field to store one or more category identifiers, and an advertiser measured location information field to store advertiser measured location information. The plurality of instructions also include instructions to store advertiser measured location information in at least each advertiser entry of a second subset of the plurality of advertiser entries, where the second subset of the plurality of advertiser entries is a subset of the first subset of the plurality of advertiser entries. The computer-readable medium also stores instructions to receive user measured location information and receive a user advertiser category identifier. The instructions also include instructions to select one or more advertiser entries of the plurality of advertiser entries based at least in part on the user advertiser category identifier and instructions to present the selected one or more advertiser entries based at least in part on the user measured location information and the advertiser measured location information of the selected one or more advertiser entries.

### BRIEF DESCRIPTION OF THE DRAWINGS

FIG. 1 is a schematic diagram of an embodiment of the present invention.

FIG. 2 is a schematic diagram of another embodiment of the present invention.

FIG. 3 is a schematic diagram of another embodiment of the present invention.

FIG. 4 shows a method in accordance with an embodiment of the present invention.

FIG. 5 shows an illustration of how advertiser listing information lacking measured location information can be presented to a user.

FIG. 6 shows an illustration of how advertiser listing information can be presented to a user.

Before embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

According to an embodiment of the present invention, an advertiser (e.g., a company, a corporation, a partnership, an organization, an individual, etc.) pays a fee to include its measured location information in a location-based yellow pages database of a location-based yellow pages service. In another embodiment of the present invention, a user accessing a location-based yellow pages service can be charged a fee to retrieve information about advertisers that have included their measured location information in the location-based yellow pages service. As used to describe embodiments of the present invention, measured location information encompasses location information that allows a calculation of the relative distance (e.g., in miles, in kilometers, in meters, in yards, in hours, in minutes, and so on) between two locations to be determined. Examples of measured location information include location information that is based at least in part on two measured dimensions. Examples of location information that is based at least in part on two measured dimensions include X-Y location information, vector location information (e.g., an angle and distance from a point, a magnitude and direction, etc.), three dimensional location information (e.g., two-dimensional location information and height or altitude information), latitude and longitude information, Global Positioning System (“GPS”) information, and so on. Area codes or zip codes are examples of designated areas. Area code or zip code information does not allow a precise calculation of the relative distance between two locations to be determined. For example, when two locations are in the same area code or zip code, a calculation of the relative distance between the two locations cannot be determined based on the area code or zip code information. As another example, two locations in adjoining zip codes can be meters or miles apart.

A user can access the location-based yellow pages service, e.g., via a network, via the Internet, via the public switched telephone network (“PSTN”), via a wireless communications network, and so on. The measured location information of the user can be determined by the location-based yellow pages service. In another embodiment, the measured location information can be determined by a network and then used by the location-based yellow pages service. Known network systems can determine user measured location information by identifying a street address (e.g., street address with a zip code, a street address with the city and state information, etc.) based on a phone number and then querying a geographic information system with the street address information. The geographic information system can return the latitude and longitude of the street address/phone number. For example, the user measured location information can be determined via a user-entered fixed-location telephone number (e.g., a landline telephone number, a fixed-wireless local loop telephone number, etc.) and an automatic location database (e.g., an automatic location database comparable or similar to an automatic location information (“ALI”) database of an Enhanced 911 (“E-911”) system). An automatic location database can store measured location information corresponding to fixed-location telephone numbers. In an embodiment in which the user accesses the location-based yellow pages service via a computer, the measured location information of the user can be stored, for example, in a cookie on the computer (e.g., after it is determined by a network system based on a telephone number, after it is entered by the user, etc.). In another embodiment, the yellow pages service can prompt the user to enter his measured location information. In a further embodiment, the user can enter a phone number (e.g., his home phone number, his mother's home phone number, an office phone number, etc.) and the measured location information can be determined by a network position determination system and then stored in a data record (e.g., as “my house”, “mom's home”, “the office”) or used by the location-based yellow pages service.

The user can look up advertisers in a yellow pages category. The yellow pages service can present (e.g., list, announce, etc.) advertisers in order of distance from the user location, e.g., presenting the closest advertiser first, the next closest advertiser second, and so on. For example, the yellow-pages service can present the ten (10) closest advertisers, the twenty-five (25) closest advertisers, each advertiser in the same telephone exchange area as the user, each advertiser in the same area code (or area codes when there are one or more overlay area codes) as the user, each advertiser in the same local access and transport area (“LATA”) as the user, and so on. In an embodiment, the yellow-pages service can also present the distance between the advertiser and the user.

After the yellow-pages service has presented advertisers having measured location information, the yellow-pages service can present advertisers without measured location information. For example, the yellow pages service can present each advertiser without measured location information in the same telephone exchange area as the user, each advertiser in the same area code (or area codes when there are one or more overlay area codes) as the user, each advertiser in the same LATA as the user, and so on. Each advertiser without measured location can also be presented at least in part alphabetically (e.g., alphabetically, each advertiser in the same telephone exchange area presented alphabetically, each advertiser in the same area code(s) presented alphabetically, etc.) or otherwise sorted (e.g., by street address, by zip code, by phone number, by city or town, etc.).

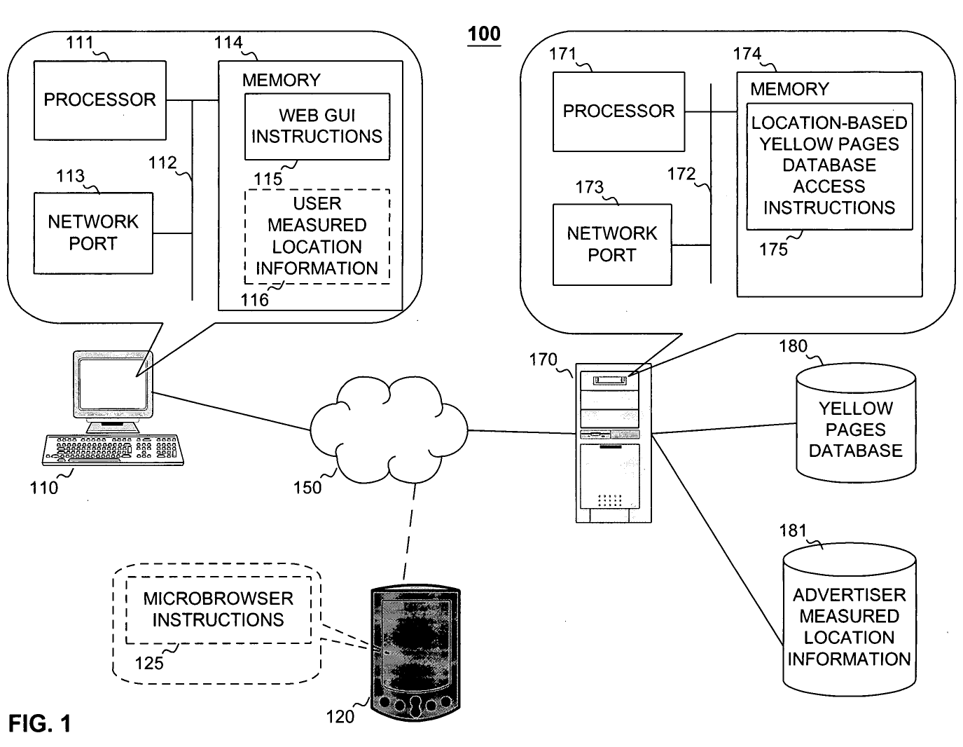

FIG. 1 is a schematic diagram of an embodiment of the present invention. System 100 includes a computer 110 of a user. Computer 110 can include a processor 111 coupled via bus 112 to network port 113 and memory 114. Processor 111 can be, for example, an Intel Pentium® 4 processor, manufactured by Intel Corp. of Santa Clara, Calif. As another example, processor 111 can be an Application Specific Integrated Circuit (ASIC). An example of bus 112 is a peripheral component interconnect (“PCI”) local bus, which is a high performance bus for interconnecting chips (e.g., motherboard chips, mainboard chips, etc.), expansion boards, processor/memory subsystems, and so on.

Network port 113 can be an Ethernet port, a serial port, a parallel port, a Universal Serial Bus (“USB”) port, an Institute of Electrical and Electronics Engineers, Inc. (“IEEE”) 1394 port, a Small Computer Systems Interface (“SCSI”) port, a Personal Computer Memory Card International Association (“PCMCIA”) port, and so on. Memory 114 of computer 110 can store a plurality of instructions configured to be executed by processor 111. Memory 114 may be a random access memory (RAM), a dynamic RAM (DRAM), a static RAM (SRAM), a volatile memory, a non-volatile memory, a flash RAM, polymer ferroelectric RAM, Ovonics Unified Memory, magnetic RAM, a cache memory, a hard disk drive, a magnetic storage device, an optical storage device, a magneto-optical storage device, or a combination thereof.

Computer 110 can be coupled to server 170 via network 150. Server 170 can be, for example, a Windows NT server from Hewlett-Packard Company of Palo Alto, Calif., a UNIX server from Sun Microsystems, Inc. of Palo Alto, Calif., and so on. Server 170 can include a processor 171 coupled via bus 172 to network port 173 and memory 174. Examples of network 150 include a Wide Area Network (WAN), a Local Area Network (LAN), the Internet, a wireless network, a wired network, a connection-oriented network, a packet network, an Internet Protocol (IP) network, or a combination thereof.

As used to describe embodiments of the present invention, the term “coupled” encompasses a direct connection, an indirect connection, or a combination thereof. Two devices that are coupled can engage in direct communications, in indirect communications, or a combination thereof. Moreover, two devices that are coupled need not be in continuous communication, but can be in communication typically, periodically, intermittently, sporadically, occasionally, and so on.

Memory 114 of computer 110 can include web graphical user interface (“GUI”) instructions 115. In an embodiment, web GUI instructions 115 can be client-side web GUI instructions (e.g., a web browser) that can manage at least in part communications between computer 110 and server 170 (e.g., a world wide web server, etc.). Examples of client-side web graphical user interface instructions include Internet Explorer 5.0 (or another version) from Microsoft Corporation of Redmond, Wash., Netscape Navigator 4.72 (or another version) from Netscape Communications of Mountain View, Calif., and so on.

Memory 174 of server 170 can include location-based yellow pages database access instructions 175, and server 170 can also include yellow pages database 180 and advertiser measured location information 181. Location-based yellow pages database access instructions 175 can manage receiving location-based yellow pages service queries from computer 110 and presenting location-based yellow page service information to computer 110. For example, computer 110 can be coupled to server 170 when the web GUI instructions 115 receive a Uniform Resource Locator (“URL”) corresponding to the location-based yellow pages service from the user. In another embodiment, the user can select the URL (e.g., by selecting a “Favorite” of Internet Explorer, a “Bookmark” of Netscape Navigator, etc.).

The location-based yellow pages database access instructions 175 can determine whether the computer 110 includes user measured location information 116 that identifies the measured location of the user and/or computer 110. For example, in an embodiment, the user measured location information 116 can be stored, for example, in a cookie that web GUI instructions 115 can access. In other embodiments, the stored user measured location information can be entered by the user, stored after a network determines the user measured location information, and so on. When the computer 110 includes user measured location information 116, the user measured location information 116 can be sent to server 170. In another embodiment, server 170 can prompt the user to enter measured location information when such information is not already stored on computer 110 or received by server 170.

Server 170 can receive a user selection of a category (e.g., hardware, music, auto parts, etc.). For example, server 170 can present the user with a field for entering text of a category. As another example, server 170 can present the user with a drop-down list of categories, and the user can select a category from the drop-down list. Other examples of ways by which a user can select a category include prompting the user to enter a search string, prompting the user to enter a key word, using partial text lookup, and so on. In an embodiment, after the server 170 has received the user-entered category, the server can return a category confirmation response to the user to confirm the user's selection of a category and/or allow the user to refine the category. For example, a category (e.g., auto parts, etc.) can include one or more subcategories (e.g., new auto parts, used auto parts, etc.). The category confirmation response can allow the user to select an appropriate refinement (e.g., a subcategory) or enter a different category. In embodiment, the category confirmation response can include a list of subcategories, a drop-down list of subcategories, and so on.

After the user has selected and/or confirmed a category, server 170 can access yellow pages database 180 and advertiser measured location information 181 to identify advertisers corresponding to the user category. In an embodiment, the yellow pages database 180 is an integrated database that includes the advertiser measured location information 181. In another embodiment, the advertiser measured location information 181 can be a database that is linked with the yellow pages database 181.

After server 170 has identified advertisers corresponding to the user category and determined any associated distance information based at least in part on the measured location information, the identified advertisers and any determined associated location information can be presented to the user. For example, the server 170 can list the advertisers for the selected category in a distance order with the closest advertiser listed first, the next closest advertiser listed next, and so on. In an embodiment, only advertisers having associated measured location information are presented to the user. In a further embodiment, the user can specify whether any advertisers lacking measured location information are to be presented. In another embodiment, advertisers having measured location information are listed first followed by advertisers lacking measured location information.

The information presented to the user for each presented advertiser can vary based on the mode of access to the location-based yellow pages service. For example, when a user accesses the service with computer 110, each presented advertiser can be presented with one or more fields of advertiser information such as an advertiser name, logo, advertisement, address (e.g., street, city, state and zip code), phone number, fax number, e-mail address, network address (e.g., URL, etc.), and/or a map. The map can show the location of the advertiser. As another example, the map can also show the location of the user. In a further embodiment, the map can show the location of more than one advertiser.

The user can select and activate (e.g., click) on a field of presented information to gain additional information, initiate a communication, and so on. For example, the user could select and activate the network address so that a web page associated with the advertiser is presented to the user (e.g., a web page with cost or product stock information, business hours, driving directions, etc.). As another example, the user can select and activate the phone number to initiate a telephone call (e.g., a Voice over Internet Protocol (“VoIP”) to the advertiser. As a further example, selecting and activating the e-mail address can cause an e-mail message window to be displayed so that the user can compose and send an e-mail to the advertiser.

According to an embodiment of the present invention, an operator of the location-based yellow pages service can realize revenue (e.g., additional revenue) by including the advertiser's measured location information as part of the location-based yellow pages service. For example, each advertiser that has measured location information included in the yellow pages database can be charged a recurring fee. The fee, in an embodiment, can be used to offset the cost of providing the location-based yellow-pages service to users. The advertiser benefits from including its measured location information in the yellow pages database because location information determined based at least in part on the measured location information can be provided to users. In an embodiment, advertisers who do not include their measured location information in the yellow pages database (e.g., advertisers who choose not to pay the additional fee) are presented last to users seeking information from the yellow pages service. Embodiments of the present invention, as compared to known art, advantageously can provide a listing of multiple advertisers associated with measured location information and allow the user to select an advertiser from one or more presented advertisers.

In another embodiment of the present invention, a wireless communications device 120 can include microbrowser instructions 125 and communicate with server 170 to receive location-based yellow pages information. Examples of microbrowser instructions 125 include a Wireless Application Protocol (“WAP”) browser, an XHTML microbrowser, another microbrowser, and so on. Examples of wireless communications device 120 include a wireless phone, a wireless personal digital assistant (“PDA”), a mobile computer, an interactive pager, a BlackBerry manufactured by Research in Motion Limited of Waterloo, Ontario, Canada, and so on. The wireless communications device 120 can transmit category selection information and measured location information. For example, the wireless communications device 120 can include a GPS receiver and decoding logic to determine the GPS location of the wireless communications device 120. In another embodiment, the wireless communications device 120 is in communication with a wireless network system that can determine the location of wireless communications device 120. Known wireless network systems that determine a location of wireless communications device can triangulate the location based at least in part on signal propagation delays, signal strength measurements, a combination thereof, and so on. When server 170 sends location-based advertiser information to the wireless communications device 120, the location-based advertiser information can be a listing of advertiser names, distance information (e.g., distance from user to advertiser, etc.), and phone number.

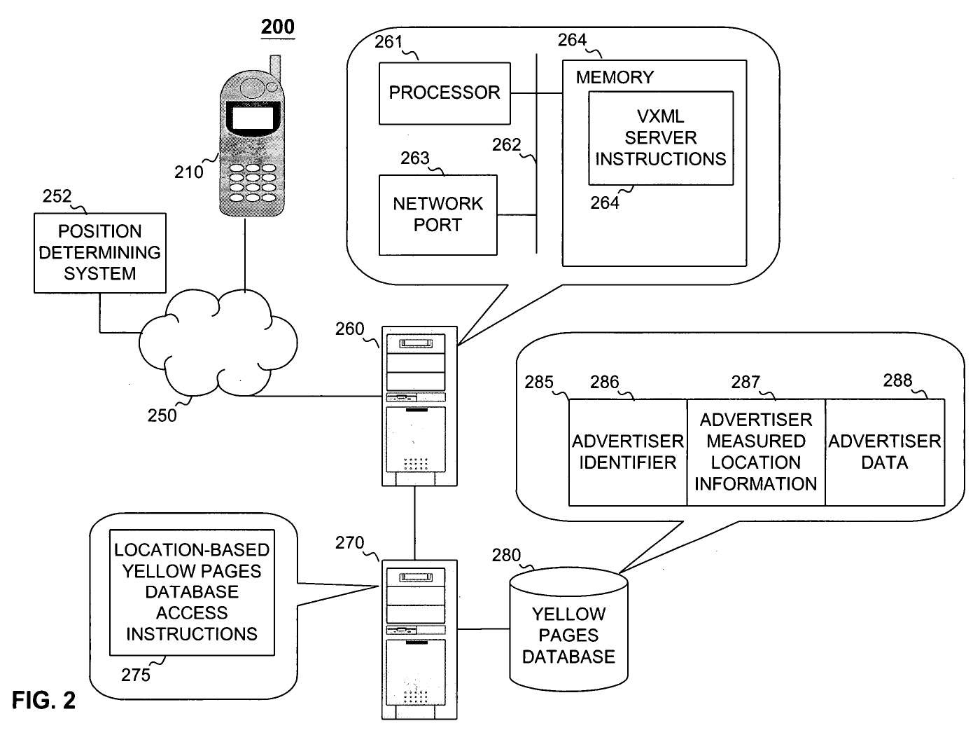

FIG. 2 is a schematic diagram of another embodiment of the present invention. System 200 can include a communications device 210 coupled to server 270 via network 250 (e.g., the PSTN, a wireless communications network, etc.) and Voice Extensible Markup Language (“VXML”) server 260. VXML is a markup language that provides voice-activated telephone access to web services. Server 270 can include location-based yellow pages database access instructions 275 that can manage communications with VXML server 260 and retrieval of information from yellow pages database 280. In another embodiment of the present invention, server 270 can include VXML server instructions 264 to manage communications with wireless communications device 210.

Yellow pages database 280 can include a plurality of advertiser entries 285. At least a subset of the plurality of advertiser entries 285 can include an advertiser identifier field to store an advertiser identifier 286 and an advertiser measured location information field to store advertiser measured location information 287. The plurality of advertiser entries 285 can also include additional advertiser data 288 such as advertiser phone number information, advertiser fax number information, advertiser address information, advertiser advertisement information, advertiser category information, and so on.

Communications device 210 can be a fixed-location communications device (e.g., a landline telephone, a fixed wireless local loop telephone, etc.) or a wireless communications device. A user can initiate a telephone call with communications device 210 to a location-based yellow pages service telephone number, and communications device 210 can be coupled to VXML server 260 and server 270. When communications device 210 is a wireless communications device, a wireless communication device position determining system 252 of the wireless network can provide the measured location information of communications device 210 (e.g., to the wireless communications device, to the wireless network, to VXML server 260 and/or server 270, and so on). For example, server 270 can send a query containing identification information of the wireless communications device (e.g., mobile telephone number, electronic serial number, mobile identification number, etc.) to the wireless network, and the wireless network can return measured location information of the wireless communications device. When communications device 210 is a fixed-location communications device, server 270 can query a location database that maps a phone number to a measured location. In another embodiment, the user measured location information is included as part of the user's service request or selection (e.g., automatically when the user is connected to the location-based yellow pages service, as part of the transmission of the user selected category, automatically when the user confirms a selection of a category or subcategory, and so on).

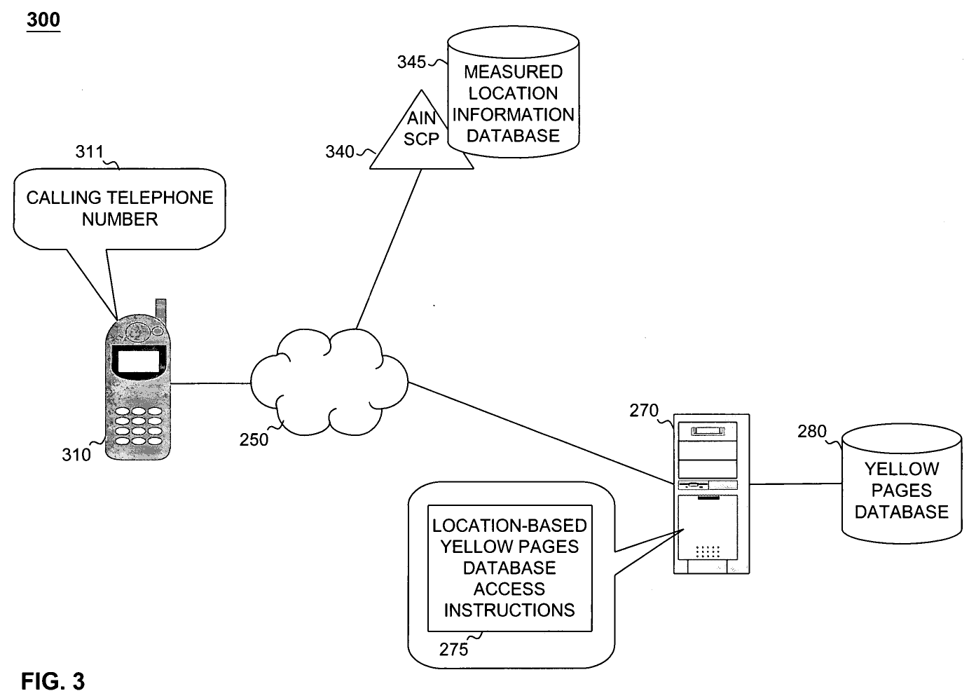

For example, FIG. 3 is a schematic diagram of another embodiment of the present invention. Server 270 can send a query containing the telephone number 311 of a fixed-location communications device 310 to Advanced Intelligent Network (“AIN”) Service Control Point (“SCP”) 340 including measured location information database 345. The SCP 340 can reply to the query with measured location information corresponding to the fixed-location communications device. For example, a known system that stores similar or comparable information is an Enhanced 911 (“E-911”) service that includes an Automatic Number Identification (“ANI”) system and an Automatic Location Information (“ALI”) system. When the E-911 system receives a call, the ANI system identifies the calling number and the ALI system can provide the measured location information of the calling number.

Referring again to FIG. 2, in another embodiment, the server 270 can initiate a communications session with a location operator that can receive location descriptive information from the user (e.g., a spoken street address, a description of an intersection, etc.). When the location operator can determine the measured location information of the user, measured location information can be sent to server 270 by the location operator. In a further embodiment, server 270 access to speech-to-text converter or an IVR unit to allow the user to interact and provide information that can be used to determine the measured location information of the user.

The user can select a category by speaking (e.g., speech-to-text, IVR, etc.), pressing phone keys (for a WAP device or Touch-Tone phone), and so on. In an embodiment of the present invention, a user can enter text using the multi-tap text entry method (e.g., pressing the 2 key once is an “a”, pressing the 2 key twice is a “b”, pressing the 2 key three times is a “c”, pressing the 3 key once is a “d”, pressing the 3 key twice is an “e”, and so on). In another embodiment of the present invention, text can be entered from a telephone keypad using T9® text input. T9 technology typically requires just one key press per letter. For example, to enter the word “how,” a user can spell out the word by pressing just three keys, 4-6-9. T9 text input technology recognizes that the most commonly used word matching that numeric sequence is “how.” Using multi-tap, it takes twice as many key presses to enter “how.” If more than one word shares the same numeric sequence, T9 text input technology provides the most commonly used word, with the ability for the user to scroll to the next most commonly used word by pressing, for example, the zero (NEXT) key.

In an embodiment, after the server 270 has received the user-entered category, the server can return a category confirmation response to the user to confirm the user's selection of a category and/or allow the user to refine the category. For example, a category (e.g., auto parts, etc.) can include one or more subcategories (e.g., new auto parts, used auto parts, etc.). The category confirmation response can allow the user to select an appropriate refinement (e.g., a subcategory) or enter a different category. In an embodiment, the category confirmation response can use IVR or touch-tone code to confirm the category or selection of a subcategory (e.g., “Press or speak 1 to confirm that your category is auto parts, press or speak 2 to select the subcategory of used auto parts, press or speak 3 to select the subcategory of new auto parts, press or speak 4 to select another category” and so on.).

After the user has selected and/or confirmed a category, server 270 can access yellow pages database 180 and advertiser measured location information 181 to identify advertisers corresponding to the user category. After server 270 has identified advertisers corresponding to the user category and determined any associated location information based at least in part on the measured location information, the identified advertisers and any determined associated location information can be presented (e.g., spoken, recited, and so on) to the user. For example, server 270 can present the advertisers for the selected category in a distance order with the closest advertiser presented first, the next closest advertiser presented next, and so on. In an embodiment, only advertisers having associated measured location information are presented to the user. In a further embodiment, the user can specify whether any advertisers lacking measured location information are to be presented (e.g., “Press or speak 1 to list only advertiser having measured location information; Press or speak 2 to list each advertiser.”). In another embodiment, advertisers having measured location information are presented first followed by advertisers lacking measured location information.

The information presented to the user for each presented advertiser can vary based on the mode of access to the location-based yellow pages service. For example, when a user accesses the service with communications device 210, each presented advertiser ultimately can be presented with one or more fields of advertiser information such as of an advertiser name, logo, advertisement, address (e.g., street, city, state and zip code), phone number, fax number, e-mail address, network address (e.g., URL, etc.), and so on. For example, after the first advertiser is presented, the user can be prompted whether additional information about that advertiser is desired (e.g., “Press or speak 1 to hear a recorded advertisement; press or speak 2 to hear the telephone number; press or speak 3 to be connected to the advertiser, . . . ”).

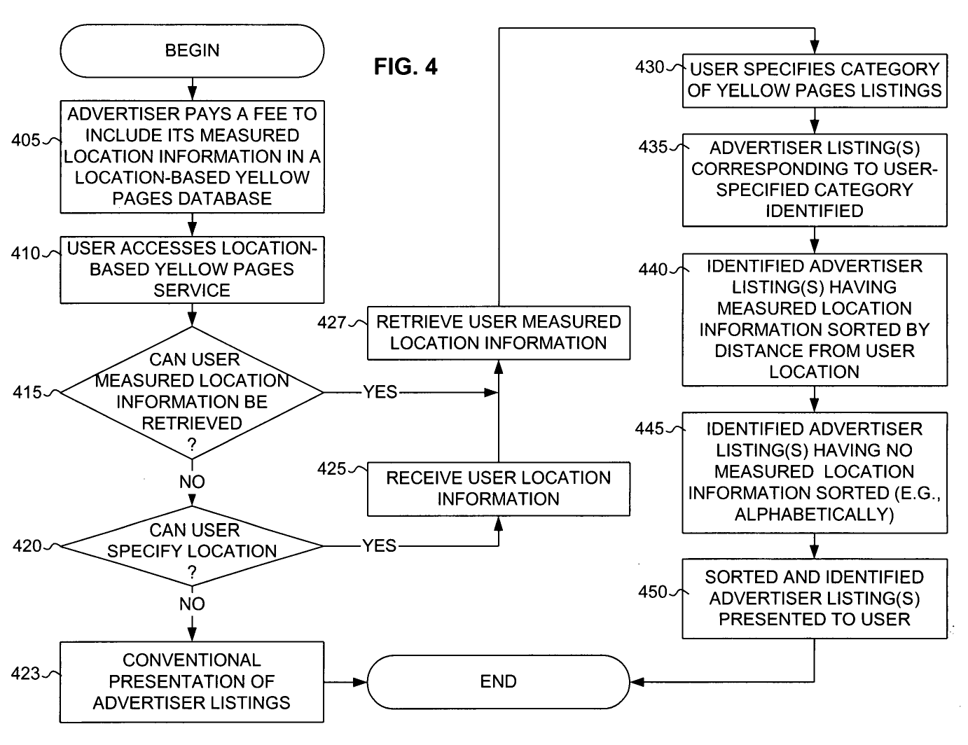

FIG. 4 shows a method in accordance with an embodiment of the present invention. An advertiser pays a fee to include its measured location information in a location-based yellow pages database (step 405). A user accesses a location-based yellow pages service including the location-based yellow pages database (step 410). Whether the user measured location can be retrieved (e.g., from a cookie on a computer, from a database that can be queried, etc.) is determined (step 415). When the user measured location cannot be retrieved, whether the user can specify his or her location is determined (step 420). When the user cannot specify his or her location, advertiser listing information can be presented in a conventional known manner (e.g., sorted by zip code, area code, etc.) (step 423). When the user can specify his or her location, the user location information is received from the user (step 425), and the user measured location information can be retrieved based on the user location information (step 427). The user can specify a category of yellow pages listings (step 430). One or more advertiser listings corresponding to the user-specified category can be identified (step 435). Identified advertiser listings having measured location information can be sorted by distance from the user location (step 440). Identified advertiser listings having no measured location information can be sorted (e.g., alphabetically). The sorted and identified advertiser listing information can be presented (e.g., sent, announced, e-mailed, etc.) to the user (step 450).

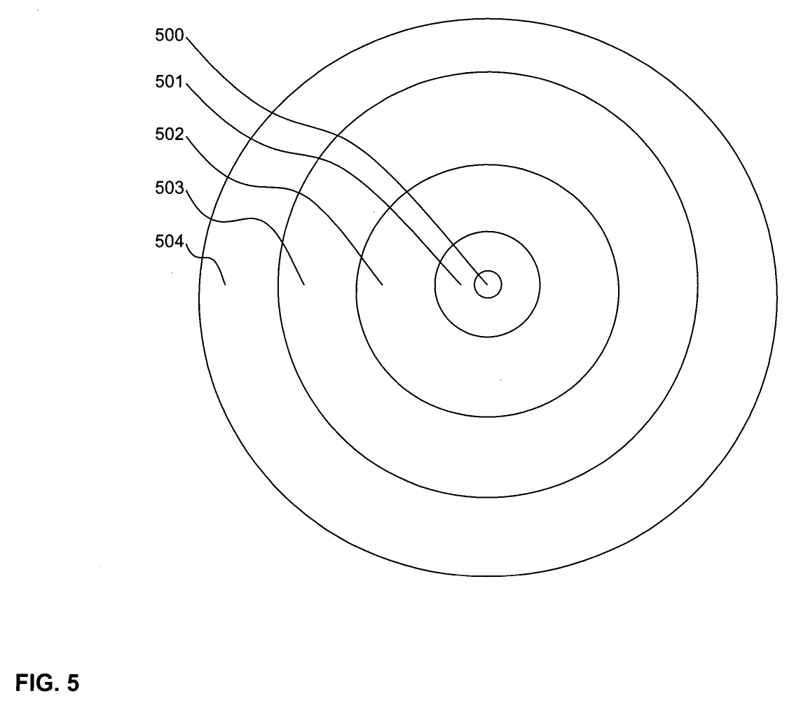

FIG. 5 shows an illustration of how advertiser listing information lacking measured location information (e.g., latitude and longitude information, etc.) can be presented to a user. For example, in an embodiment of the present invention, identified advertiser listings having measured location information can be sorted and presented by distance from a user location, and identified advertiser listings having no measured location information can be sorted alphabetically. FIG. 5 illustrates how the identified advertiser listing having no measured location information can be presented to the user based at least in part on telephone exchange area, zip code, area code, and LATA information.

Typically, a rough approximation of how proximate an advertiser may be to a user can be based on whether the advertiser has the same telephone exchange area, same zip code, same area code area, and/or same LATA as the user. If the user is in the same telephone exchange area as a first advertiser, and in a different telephone exchange area from a second advertiser, the user is likely to be closer to the first advertiser. Likewise, if the user is in the same area code area (e.g., having the same area code or an overlay area code of the area code) as a third advertiser, and in a different area code area from a fourth advertiser, then the user is likely to be closer to the third advertiser.

Based on such rough approximations, FIG. 5 illustrates how close advertisers without measured location information may be to a user location 500. Area 501 illustrates advertisers having the same telephone exchange area as user location 500. Area 502 illustrates advertisers having the same zip code area as user location 500. Area 503 illustrates advertisers having the same area code area as user location 500 (when a zip code area is smaller than an area code area). Area 504 illustrates advertisers in the same LATA as user location 500. When advertiser listing information lacking measured location information (e.g., latitude and longitude information, etc.) is to be presented to a user, advertisers of area 501 can be presented before advertisers of area 502, advertisers of area 502 can be presented before advertisers of area 503, advertisers of area 503 can be presented before advertisers of area 504, and so on.

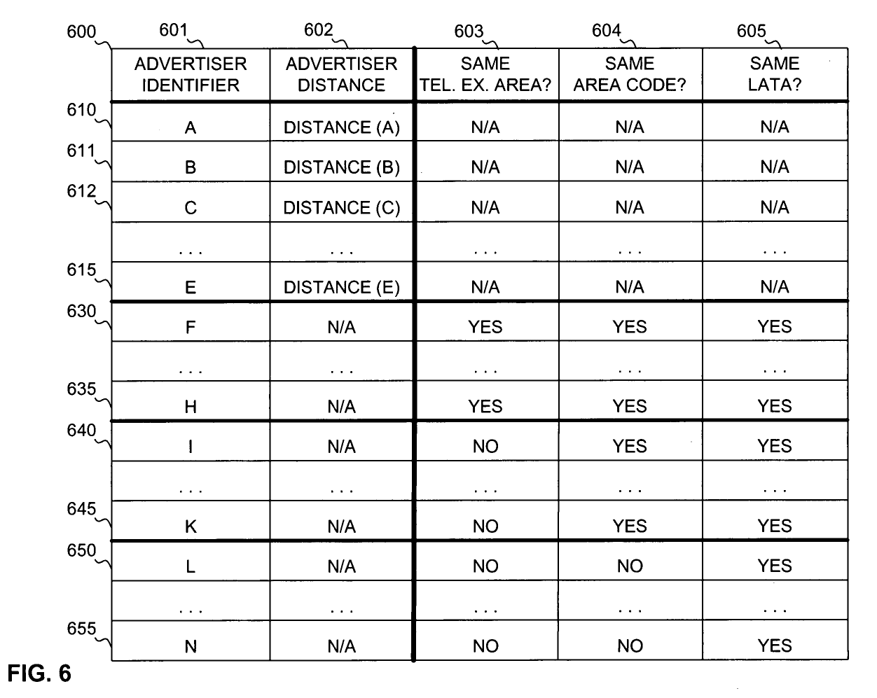

FIG. 6 shows an illustration of how advertiser listing information can be presented to a user. Table 600 includes an advertiser identifier field 601 to store an advertiser identifier and an advertiser distance field 602 to store an advertiser distance from a user location. Table 600 also includes explanation fields 603, 604 and 605 that illustrate why certain advertisers are listed prior to other advertisers. In an embodiment, table 600 can include one or more advertiser information entries 610-655, each of which corresponds to an advertiser.

Advertiser entries 610 to 615 can include information about at least advertisers A to E, each of which have measured location information stored in a yellow pages database. The distance between the user location and the advertiser can therefore be calculated based at least in part on the advertiser measured location information and presented to the user. The distance can be an absolute distance (e.g., distance “as the crow flies”), fastest driving distance, shortest travel distance, a distance in time when driving, a distance in time when walking, a distance in time when bicycling, and so on. For example, in an embodiment in which the measured location information includes location information based at least in part on three measured dimensions (e.g., latitude, longitude, and altitude), the calculated distance can include differences in altitude. For example, a user in a city may be looking for a bar or restaurant and may be at the foot of a skyscraper. The location-based yellow pages service can take into consideration that a bar one block away at street level is closer than a bar in the skyscraper but on the 40^{th} floor of the skyscraper (e.g., closer based on distance, closer based on travel time, etc.).

Advertiser entries 630 to 635 can be presented to the user after advertiser entries 610 to 615. Advertiser entries 630 to 635 correspond to at least advertisers F to H, each of which do not have measured location information stored in the yellow pages database. Advertisers entries 630 to 635 can be presented after advertiser entries 610 to 615 but prior to other advertiser entries because advertisers F to H are in the same telephone exchange area as the user.

Advertiser entries 640 to 645 can be presented to the user after advertiser entries 630 to 635. Advertiser entries 640 to 645 correspond to at least advertisers I to K, each of which do not have measured location information stored in the yellow pages database. Advertisers entries 640 to 645 can be presented after advertiser entries 630 to 635 but prior to other advertiser entries because advertisers I to K are in the same area code area as the user.

Advertiser entries 650 to 655 can be presented to the user after advertiser entries 640 to 645. Advertiser entries 650 to 655 correspond to at least advertisers L to N, each of which do not have measured location information stored in a yellow pages database. Advertisers entries 650 to 655 can be presented after advertiser entries 640 to 645 but prior to other advertiser entries because advertisers L to N are in the same LATA as the user.

Embodiments of the present invention relate to data communications via one or more networks. The data communications can be carried by one or more communications channels of the one or more networks. A network can include wired communication links (e.g., coaxial cable, copper wires, optical fibers, a combination thereof, and so on), wireless communication links (e.g., satellite communication links, terrestrial wireless communication links, satellite-to-terrestrial communication links, a combination thereof, and so on), or a combination thereof. Moreover, a network can be circuit-switched, packet-switched, a combination thereof, and so on. A communications link can include one or more communications channels, where a communications channel carries communications. For example, a communications link can include multiplexed communications channels, such as time division multiplexing (“TDM”) channels, frequency division multiplexing (“FDM”) channels, code division multiplexing (“CDM”) channels, wave division multiplexing (“WDM”) channels, a combination thereof, and so on.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Systems and methods in accordance with an embodiment of the present invention disclosed herein can advantageously allow a user to search for advertisers from a yellow pages database of a yellow pages service. The advertisers can include measured location information in the yellow pages service (e.g., as part of the yellow pages database). Users can select a category of advertisers. The yellow pages service can present advertisers of that category to the user, and advertiser information based at least in part on the advertiser's measured location information can be presented to the user.

Embodiments of systems and methods for location-based yellow page services have been described. In the foregoing description, for purposes of explanation, numerous specific details are set forth to provide a thorough understanding of the present invention. It will be appreciated, however, by one skilled in the art that the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the present invention.

In the foregoing detailed description, systems and methods in accordance with embodiments of the present invention have been described with reference to specific exemplary embodiments. Accordingly, the present specification and figures are to be regarded as illustrative rather than restrictive. The scope of the invention is to be defined by the claims appended hereto, and by their equivalents.

1. (Cancelled).

2. (Cancelled).

3. The system of claim 15, wherein each advertiser entry of at least the subset of the plurality of advertiser entries includes additional advertiser data.

4. (Cancelled).

5. (Cancelled).

6. (Cancelled).

7. (Cancelled).

8. (Cancelled).

9. (Cancelled).

10. The system of claim 15, further comprising a voice extensible markup language server coupled to the server.

11. The system of claim 15, wherein the server includes voice extensible markup language server instructions.

12. The system of claim 15, wherein the server is configured to communicate with a user computer, the user computer including web graphical user interface instructions and user measured location information.

13. The system of claim 15, wherein the server is configured to communicate with a wireless communication device, the wireless communications device including microbrowser instructions.

14. The system of claim 15, further comprising:
an advanced intelligent network (“AIN”) service control point (“SCP”) coupled to the server, the AIN SCP coupled to a measured location information database, the AIN SCP configured to receive a phone number location query including a phone number and to send a location response including measured location information associated with the phone number.

15. A system for providing location-based yellow pages information, the system comprising:
a server including
a processor,
a network port coupled to the processor, and
a memory coupled to the processor, the memory storing a plurality of instructions configured to be executed by the processor, the plurality of instructions including location-based yellow pages database access instructions; and
a yellow pages database coupled to the server, the yellow pages database including a plurality of advertiser entries, wherein the plurality of advertiser entries include at least a first subset of advertiser entries and a second subset of advertiser entries, each advertiser entry of the first subset of advertiser entries includes advertiser measured location information, and each advertiser entry of the second subset of advertiser entries lacks advertiser measured location information,
wherein the processor is configured to:
receive a request of yellow page information from the user, the request including user measured location information and a user selected advertiser category identifier, wherein the user measured location information is determined using one of information obtained from a telecommunication system and information pre-stored in the memory;
responding to the request returning a confirmation query to the user wherein the returned confirmation requery confirms the user selected advertiser category and allows the user to refine the selection of the advertiser category identifier and a user advertiser subcategory identifier, and wherein the confirmation message further allows the user to determines whether to retrieve advertiser entries from the second subset of the plurality of the advertiser entries;
retrieve one or more advertiser entries from at least one of the first subset and the second subset of the plurality of advertiser entries based at least in part on at least one of user measured location information, the user selected advertiser category identifier and the user selected advertiser subcategory identifier; and
present the retrieved one or more advertiser entries based at least in part on the user measured location information and the advertiser measured location information of the selected one or more advertiser entries.

16. (Cancelled).

17. (Cancelled).

18. The system of claim 15, wherein the advertiser measured location information is based at least in part on latitude and longitude information.

19. The system of claim 15, wherein the advertiser measured location information is based at least in part on two-dimensional location information.

20. The system of claim 15, wherein the advertiser measured location information is based at least in part on three-dimensional location information.

21. The system of claim 15, wherein the server is configured to receive a user phone number and send a location query including the user phone number.

22. The system of claim 21, wherein the server sends the location query to a wireless network.

23. The system of claim 21, wherein the server sends the location query to an advanced intelligent network service control point.

24. The system of claim 15, wherein:
each advertiser entry of the first subset and second subset of the plurality of advertiser entries includes an advertiser category identifier field to store one or more advertiser category identifiers; and
the server is configured to receive user measured location information and a user advertiser category identifier.

25. The system of claim 24, wherein:
the server identifies one or more advertiser entries of the first subset of the plurality of advertiser entries based at least in part on the user advertiser category identifier;
the server presents the identified one or more advertiser entries of the first subset of the plurality of advertiser entries based at least in part on
the user measured location information, and
the advertiser measured location information of the identified one or more advertiser entries of the first subset of the plurality of advertiser entries;
the server identifies one or more advertiser entries of the second subset of the plurality of advertiser entries based at least in part on the user advertiser category; and
the server presents the identified one or more advertiser entries of the second subset of the plurality of advertiser entries.

26. A method for providing location-based yellow pages database, the method comprising:
storing a plurality of advertiser entries in a yellow page database, wherein the plurality of advertiser entries include at least a first subset of advertiser entries and a second subset of advertiser entries, each advertiser entry of the first subset of advertiser entries includes an advertiser identifier field to store an advertiser identifier, an advertiser category identifier field to store one or more category identifiers, and an advertiser measured location information field to store advertiser measured location information;
storing advertiser measured location information in at least each advertiser entry of the second subset of the plurality of advertiser entries, the second subset of the plurality of advertiser entries being a subset of the first subset of the plurality of advertiser entries;
receiving a request for a yellow page information from a user, the request including user measured location information and a user selected advertiser category identifier, wherein the user measured location information is determined using one of information obtained from a telecommunication system and information pre-stored in the memory;
responding to the request returning a confirmation query to the user, wherein the returned confirmation query confirms the user selected advertiser category and allows the user to refine the selection of the advertiser category identifier and a user advertiser subcategory identifier, and wherein the confirmation message further allows the user to determines whether to retrieve advertiser entries without advertiser measured location information;
retrieving one or more advertiser entries of the plurality of advertiser entries from the yellow page database based at least in part on at least one of the user advertiser category identifier and the user advertiser sub-category identifier; and
presenting the retrieved one or more advertiser entries based at least in part on the user measured location information and the advertiser measured location information of the selected one or more advertiser entries.

27. The method of claim 26, wherein receiving user measured location information includes receiving user measured location information sent by a communication device selected from the group consisting of a computer, a fixed-location telephone, a wireless telephone, a wireless communications device, a wireless communications network, and an advanced intelligent network service control point.

28. The method of claim 26, wherein receiving a user advertiser category identifier includes:
sending a user advertiser confirmation query;
receiving a user advertiser confirmation response.

29. The method of claim 28, wherein sending the user advertiser confirmation query includes sending one or more advertiser subcategories.

30. The method of claim 26, wherein receiving user measured location information includes sending a cookie based at least in part on the user measured location information to a user computer.

31. The method of claim 26, wherein presenting the selected one or more advertiser entries based at least in part on the user measured location information and the advertiser measured location information of the selected one or more advertiser entries includes:
determining distance data between the user measured location information and the advertiser measured location information of the selected one or more advertiser entries; and
organizing a listing of the selected one or more advertising entries based at least in part on the determined distance data.

32. The method of claim 31, wherein organizing a listing includes organizing from a smallest distance to a largest distance.

33. The method of claim 31, wherein organizing a listing includes organizing from a smallest time period to a largest time period.

34. The method of claim 31, wherein selecting one or more advertiser entries of the plurality of advertiser entries based at least in part on the user advertiser category identifier includes:
selecting one or more advertiser entries of the second subset of the plurality of advertiser entries based on at least in part on the user advertiser category identifier; and
selecting one or more advertising entries of a third subset of the plurality of advertiser entries based at least in part on the user advertiser category identifier, the selected one or more advertiser entries of the third subset of the plurality of advertiser entries lacking advertiser measured location information.

35. The method of claim 34, wherein presenting the selected one or more advertiser entries based at least in part on the user measured location information and the advertiser measured location information of the selected one or more advertiser entries includes:
organizing a listing of the selected one or more advertising entries of the second subset of the plurality of advertiser entries based at least in part on
the user measured location information, and
the advertiser measured location information of the selected one or more advertising entries of the second subset of the plurality of advertiser entries; and
organizing a listing of the selected one or more advertising entries of the third subset of the plurality of advertiser entries.

36. The method of claim 35, wherein organizing the listing of the selected one or more advertising entries of the third subset of the plurality of advertiser entries is based at least in part on a telephone exchange area and an area code.

37. The method of claim 36, wherein organizing the listing of the selected one or more advertising entries of the third subset of the plurality of advertiser entries is further based at least in part on at least one of a zip code area and a local access and transport area.

38. The method of claim 26, wherein the advertiser measured location information and the user measured information are based at least in part on longitude and latitude information.

39. The method of claim 26, wherein the advertiser measured location information and the user measured location information are based at least in part on two-dimensional location information.

40. A method of providing a location-based yellow pages service, the method comprising:
operating a yellow pages service, the yellow pages service including a yellow pages database, the yellow page database including a first set of advertiser entries and a second set of advertiser entries, the first set of advertiser entries including advertiser measured location information, the second set of advertiser entries lacking advertiser measured location information;
receiving a request from a user to present advertiser information corresponding to a user selected advertiser category and a user selected advertiser subcategory;
responding to the request returning a confirmation query to the user, wherein the returned confirmation message confirms the user selected advertiser category and allows the user to refine the selection of the advertiser category identifier and a user advertiser subcategory identifier and wherein the confirming message further allows the user to determine whether to retrieve advertiser entries from the second set of advertiser entries;
presenting a list of advertiser information from the first set of advertiser entries including advertiser measured location information prior to presenting a list of advertiser information from the second set of advertiser entries lacking advertiser measured location information; and
charging the advertisers corresponding to the first set of advertiser entries a fee to include advertiser measured location information in the yellow page database.

41. (Currently Canceled)

42. A method of providing a location-based yellow pages service, the method comprising:
operating a yellow pages service, the yellow pages service including a first advertiser's information and a second advertiser's information, the first advertiser's information including measured location information, the second advertiser's information lacking measured location information;
receiving a request for yellow page information from a user, the request including user measured location information and a user selected advertiser category identifier, wherein the user measured location information is determined using one of information from a telecommunication system and information pre-stored in a memory;
responding to the request sending a user advertiser confirmation query to the user; wherein sending the user advertiser confirmation query includes sending one or more advertiser subcategories, wherein the confirmation query confirms the user selected advertiser category identifier and allows the user to refine the selection of the advertiser category identifier and a user advertiser subcategory identifier, and wherein the confirmation message further allows the user to determine whether to retrieve the second advertiser information;
receiving a user advertiser confirmation response from the user, wherein the user advertiser confirmation response includes a user selected advertiser subcategory identifier and a determination whether to retrieve the second advertiser information;
upon receiving the user advertiser confirmation response from the user, retrieving one or more first and second advertiser's information from the yellow page database,
presenting the retrieved one or more advertiser's information in a manner that the first advertiser's information are displayed prior to the second advertiser's information; and
charging the first advertiser an additional fee based at least in part on including measured location information as part of the first advertiser's information.

43. (Previously Canceled)

44. A system for providing location-based yellow page information, the system comprising:
means for storing a plurality of advertiser entries in a yellow page database, wherein the plurality of advertiser entries include at least a first subset of advertiser entries, a second subset of advertiser entries, and a third subset of advertiser entries, each advertiser entry of the first subset of advertiser entries includes an advertiser identifier field to store an advertiser identifier, an advertiser category identifier field to store one or more category identifiers, and an advertiser measured location information field to store advertiser measured location information;
means for storing advertiser measured location information in at least each advertiser entry of the second subset of the plurality of advertiser entries, the second subset of the plurality of advertiser entries being a subset of the first subset of the plurality of advertiser entries;
means for storing advertiser identifiers in at least each advertiser entry of the third subset of the plurality of advertiser entries, the advertiser identifiers in the third subset lacks advertiser measured location information;
means for receiving a request for a yellow page information from a user, the request including user measured location information and a user selected advertiser category, wherein the user measured location information is determined using one of information from a telecommunication system and information pre-stored in a memory;
means for, responding to the request, sending a user advertiser confirmation query to the user; wherein sending the user advertiser confirmation query includes sending one or more advertiser subcategories, wherein the confirmation query confirms the user selected advertiser category identifier and allows the user to refine the selection of the advertiser category identifier and a user advertiser subcategory identifier, and wherein the confirmation message further allows the user to determine whether to retrieve the third advertiser information
means for retrieving one or more advertiser entries of the plurality of advertiser entries from the yellow page database based at least in part on the user advertiser category identifiers, the. user advertiser sub-category identifier, and the user's determination whether to retrieve the third advertiser information; and
means for presenting the retrieved one or more advertiser entries based at least in part on the user measured location information and the advertiser measured location information of the selected one or more advertiser entries.

45. The system of claim 44, wherein the advertiser measure location information and the user measured location information are based at least in part on longitude and latitude information.

46. The system of claim 44, wherein the advertiser measured location information and the user measured location information are based at least in part on two-dimensional location information.

47. The system of claim 44, wherein the advertiser measured location information and the user measured location information are based at least in part on three-dimensional location information.

48. (Cancelled).

49. (Cancelled).

50. (Cancelled).

51. A computer-readable medium storing a plurality of instructions to be executed by a processor for providing location-based yellow page information, the plurality of instructions comprising instructions to:
store a plurality of advertiser entries in a yellow page database, the plurality of advertiser entries including at least a fist subset of advertiser entries, a second subset of advertiser entries, and a third subset of advertiser entries, each advertiser entry of the first subset of advertiser entries including an advertiser identifier field to store an advertiser identifier, an advertiser category identifier field to store one or more category identifiers, and an advertiser measured location information field to store advertiser measured location information;
store advertiser measured location information in at least each advertiser entry of the second subset of the plurality of advertiser entries, the second subset of the plurality of the advertiser entries being a subset of the first subset of the plurality of advertiser entries;
store advertiser identifiers in at least each advertiser entry of the third subset of the plurality of advertiser entries, the advertiser identifiers in the third subset lacks advertiser measured location information;
receive a request for a yellow page information from a user, the request including user measured location information that is determined by one of information obtained from a telecommunications system and information pre-stored in a memory;
receive a user selected advertiser category identifier from the user;
in response to the request and user selected advertiser category identifier, send an advertiser confirmation query to the user, wherein the advertiser confirmation query confirms the user selected advertiser category identifier and includes one or more advertiser subcategories, wherein the confirmation query allows the user to refine the selection of the advertiser category identifier and the one or more advertiser subcategories, and wherein the confirmation query further allows the user to determine whether to retrieve the advertiser entries from the third subset of the plurality of advertiser entries;
receive a user advertiser confirmation response from the user, wherein the user advertiser confirmation response includes a user selected advertiser subcategory identifier and the user's determination whether to retrieve the advertiser entries from the third subset;
retrieve one or more advertiser entries of the plurality of advertiser entries from the yellow page database based on the user advertiser confirmation response; and
present the retrieved one or more advertiser entries based at least in part on the user measured location information and the advertiser measured location information of the retrieved one or more advertiser entries.

52. The system of claim 51, wherein the advertiser measure location information and the user measured location information are based at least in part on longitude and latitude information.

53. The system of claim 51, wherein the advertiser measured location information and the user measured location information are based at least in part on two-dimensional location information.

54. The system of claim 15, wherein the retrieved one or more advertiser entries are listed and organized by the processor to include a first sub-listing of one or more advertiser entries with advertiser measured location information and a second sub-listing of one or more advertiser entries without advertiser measured location information.

55. The system of claim 15, wherein the user measured location information is based at least in part on one of latitude and longitude information, two-dimensional location information, three-dimensional location information, telephone exchange area, zip code, area code and a local access and transport area.

56. The method of claim 26, wherein the retrieved one or more advertiser entries are listed and organized to include a first sub-listing of one or more advertiser entries with advertiser measured location information and a second sub-listing of one or more advertiser entries without advertiser measured location information.

57. The method of claim 26, wherein the user measured location information is based at least in part on one of latitude and longitude information, two-dimensional location information, three-dimensional location information, telephone exchange area, zip code, area code and a local access and transport area.

58. The method of claim 34, wherein selecting one or more advertiser entries of the third subset of the plurality of advertiser entries based at least in part on at least one of a telephone exchange area, a zip code, a area code, and a local access and transport area.

59. The method of claim 56, wherein the second sub-listing of one or more advertiser entries without advertiser measured location information are sorted by at least one of a telephone exchange area, a zip code, an area code and a local access and transport area.

60. The method of claim 56, wherein the first sub-listing of one or more advertiser entries with advertiser measured location information is sorted by at least one of a distance and time period between the user and the one or more advertiser entries.

61. The system of claim 44, wherein organizing the listings is based at least in part on at least one of longitude and latitude information, two-dimensional location information, three-dimensional location information, a telephone exchange area, a zip code, a area code, and a local access and transport.

62. A system for providing location-based yellow pages information, the system comprising:
a processor;
a yellow page database coupled to the processor, the yellow page database including a plurality of advertiser entries, wherein the plurality of advertiser entries includes a first subset of advertiser entries and a second subset of advertiser entries, each advertiser entry of the first subset of advertiser entries includes advertiser measured location information, and each advertiser entry of the second subset of advertiser entries lacks advertiser measured location information; and
a memory coupled to the processor, the memory storing a plurality of instructions configured to be executed by the processor, the plurality of instructions including location-based yellow pages database access instructions, and
wherein the processor is configured to
receive a request for yellow page information from a user, the request including at least one of a user measured location information, a user selected advertiser category and a user selected advertiser subcategory;
responding to the request, returning a confirmation query to the user, wherein the confirmation query confirms the user selected advertiser category and the user selected advertiser subcategory and allows the user to refine the selection of the category and the sub-category, and the confirmation query allows the user to determine whether to retrieve advertiser entries from the second subset of advertiser entries;
based on the request received from the user, retrieving one or more advertiser entries from the yellow page information database; and
presenting the retrieved one or more advertiser entries in an order that the advertiser entries of the first subset are presented prior to those of the second subset.

63. The system of claim 15, wherein the process presents the selected one or more advertiser entries in a manner that the advertiser entries of the first subset are presented prior to the advertiser entries of the second subset.

64. The method of claim 26, wherein the retrieved one or more advertiser entries are presented in a manner that the advertiser entries of the first subset are presented prior to the advertiser entries of the second subset.

65. The system of claim 44, wherein the means for presenting the retrieved one or more advertiser entries presents the retrieved one or more advertiser entries in a manner that the advertiser entries of the first subset are presented prior to the advertiser entries of the second subset, and the advertiser entries of the second subset are presented prior to the advertiser entries of the third subset.

66. The method of claim 51, the retrieved one or more advertiser entries are presented in a manner that the advertiser entries of the first subset are presented prior to the advertiser entries of the second subset, and the advertiser entries of the second subset are presented prior to the advertiser entries of the third subset.
